(19) United States
(12) Patent Application Publication
(10) Pub. No.: US 2026/0310497 A1
(43) Pub. Date: Oct. 8, 2026

(54) METHODS AND SYSTEMS FOR SELF-HEALING ARTIFICIAL INTELLIGENCE

(71) Applicant: Panasonic Well LLC, Palo Alto, CA (US)

(72) Inventors: David Justus, Brooklyn, NY (US); Sandy Anuras, Seattle, WA (US); Adrian Syzmczak, Poznan (PL)

(21) Appl. No.: 19/339,771

(22) Filed: Sep. 25, 2025

Related U.S. Application Data
(60) Provisional application No. 63/783,636, filed on Apr. 4, 2025.

(51) Int. Cl. G06F 9/48; G06F 9/50

(52) U.S. Cl. CPC G06F 9/4881; G06F 9/5066

(57) ABSTRACT

An AI Agent Platform implements self-healing within AI modules for fault tolerant task execution. The AI Agent Platform may receive a task and an identification of an intent associated with the task. The AI Agent Platform may execute a specialist module using an object derived from the task and the intent. The specialist module defines a sequence of subtasks configured to implement the task. The specialist module can invoke an agent module to execute a first subtask and analyzes a resulting state of the task in response to executing the first subtask. If the state of the task indicates a failure condition, the specialist module may be executed again using a new object derived from the task and the state of the task to generate a new sequence of tasks that extend from the first subtask. The specialist module invokes a second agent module to execute the second subtask.

### CROSS-REFERENCE TO RELATED APPLICATIONS

The present application claims the benefit of U.S. Provisional Application 63/783,636 filed Apr. 4, 2025 and is related to U.S. Non-Provisional Application entitled “AI AGENT PLATFORMS” filed Sep. 25, 2025 (Attorney Docket No.: 109304-855123-009600US), U.S. Non-Provisional Application entitled “GRAPHICAL EDITOR FOR COMPLEX ARTIFICIAL INTELLIGENCE AGENT SYSTEMS” filed Sep. 25, 2025 (Attorney Docket No.: 109304-852159-009800US) and U.S. Non-Provisional Application entitled “SYSTEMS AND METHODS FOR PROACTIVE RESPONSE GENERATION IN MULTI-USER SESSIONS” filed Sep. 25, 2025 (Attorney Docket No.: 109304-854311-009900US), each of which are incorporated herein by reference in their entireties and for all purposes.

### TECHNICAL FIELD

This disclosure relates generally to artificial intelligence platforms, and more particularly to self-healing machine-learning models and self-healing machine-learning operations.

### BACKGROUND

Artificial-intelligence (AI) systems process inputs to provide particular services to users. AI systems may be trained to perform a variety of tasks from image generation to programing. The performance of the AI systems may be related to the quality of the training data and the training processes of the AI system. The quality of the training data and the training processes can be managed during instantiation of the AI system. For example, training data can be managed through selection of datasets, feature selection, etc. The training process can be managed through various hyperparameters, accuracy metrics, and training methodologies (e.g., supervised learning, unsupervised learning, etc.). Generally, the more tasks that an AI system is configured to perform the more difficult the AI system is to train and the more likely performance of the AI system on discrete tasks degrades.

### SUMMARY

Methods are described herein for self-healing artificial intelligence. The methods include receiving, from a computing device, an identification of a task and an intent associated with the task; executing a specialist module using an object derived from the task and the intent, wherein the specialist module defines a sequence of subtasks configured to implement the task; facilitating execution of a first subtask of the sequence of subtasks, wherein the first subtask is executed by a first agent module trained to execute a single task type; determining, by the specialist module, a state of the task in response to execution of the first subtask; executing the specialist module using a new object derived from the task and the state of the task, wherein the specialist module defines new sequence of subtasks extending from the first subtask; and facilitating execution of a second subtask of the new sequence of subtasks, wherein the second subtask is executed by a second agent module trained to execute a single task type.

The systems are described herein for implementing a self-healing artificial intelligence. The systems may include one or more processors and a non-transitory computer-readable medium storing instructions that, when executed by the one or more processors, cause the one or more processors to perform any of the methods as previously described.

The non-transitory computer-readable media described herein may be configured to store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example AI Agent Platform trained for general task facilitation according to aspects of the present disclosure.

FIG. 2 illustrates a block diagram of example specialist module of the AI Agent Platform according to aspects of the present disclosure.

FIG. 3 illustrates a block diagram of an example self-healing chain-of-thought or graph-of-thought of specialist modules according to aspects of the present disclosure.

FIG. 4 illustrates a flowchart of an example process implementing self-healing AI within task facilitation of an AI Agent Platform according to aspects of the present disclosure.

FIG. 5 illustrates an example computing device architecture of an example computing device that can implement the various techniques described herein according to aspects of the present disclosure.

### DETAILED DESCRIPTION

Systems and methods are described herein for self-healing artificial intelligence (AI) within AI Agent Platforms. Conventional systems (e.g., software, AI systems, etc.) include limited fault tolerance capabilities. For example, most conventional systems use basic fault tolerance techniques such as error handling, which prevents errors from crashing or otherwise terminating processes, or process redundancy, which duplicates systems or processes in case a system or process fails. Basic fault tolerance techniques are resource intensive solutions (e.g., using duplicate hardware components such as processors and memory, processing cycles to store and manage duplicate memory regions, etc.) and often do not address the root cause of the error, which occur with increasing frequency as a result.

The self-healing AI described herein include dynamically reconfigurable processing pipelines that enable processing systems to detect error conditions and reconfigure processes prevent errors from impacting processing performance and enable processes to continue operating successfully. An AI Agent Platform may include specialist modules that execute processes of the AI Agent Platform. Specialist modules include an artificial-intelligence-based processing pipeline that manages execution of processes assigned to the specialist modules. The artificial-intelligence-based processing pipeline is dynamically reconfigurable at runtime to ensure processes execute successfully even when errors are detected. The artificial-intelligence-based processing pipeline provides fault tolerance with minimal processing overhead (e.g., without using additional hardware and/or processing redundancies) to both improve resource consumption and processing by the AI Agent Platform.

In some implementations, the artificial-intelligence-based processing pipeline of the specialist module includes a learning/planning component that receives an identification of a process and state information from an orchestrator of the AI Agent Platform. The learning/planning component may include one or more machine-learning models that divide the process into a sequence of subtasks that can be executed to execute the process. The one or more machine-learning models may be trained to reduce the process to subtasks into discrete subtasks. In some instances, the one or more machine-learning models may define subtasks that are minimally dependent on external services and other subtasks. Minimally dependent subtasks may increase parallel processing and reduce memory-based errors such as locks or stalls when memory is not available for a particular subtask due to another subtask or service. The specialist module may include a scheduler that schedules execution of the sequence of subtasks based on the task types associated with the subtasks and dependencies between subtasks. In some examples, the scheduler may schedule subtasks to execute according to the sequence of subtasks. In other instances, the scheduler may execute subtasks in parallel, out-of-order, etc. based on the subtasks and dependencies. For instance, a subtask that is self-contained (e.g., not dependent on other subtasks or external services, etc.) may execute in parallel with another subtask, etc. The scheduler may also determine when subtasks execute (e.g., according to the time of day, a system clock, etc.).

The artificial-intelligence-based processing pipeline of the specialist modules is self-healing that enables processes to execute successfully despite any errors. If execution of a subtask results in an error condition (e.g., an error, fault, exception, interrupt, etc. is generated or the subtasks executes unsuccessfully, etc.), then the specialist module may record the error condition within a state tracking component and pass the error condition to the learning/planning component. The learning/planning component may use the one or more machine-learning models to replan the process which generates a new sequence of subtask that begin after the failed subtask. The new sequence of subtasks may be defined based on the process, the state of the process at the time of the error condition, and the error condition to reduce a likelihood of the error condition reoccurring and increase a likelihood of the process executing successfully. In some examples, the learning/planning component may use the one or more machine-learning models to replan the process when an error condition is detected. In other instances, the learning/planning component may use the one or more machine-learning models to replan the process after execution of each subtask and when an error condition is detected. By replanning execution of the process after each subtask, the one or more machine-learning models learn from each stage of process execution, which may improve the efficiency of executing the process and increase a likelihood that the process will execute successfully.

The learning/planning component may include a memory that stores information associated with historical tasks and historical applications of the learning/planning component. For instance, the memory may store information associated with historical tasks processed by the learning/planning component, historical subtasks defined by the learning/planning component, an identification of failed tasks, an identification of failed subtasks, an identification of a root cause of fail tasks, an identification of a root cause of failed subtasks, metadata associated historical tasks and subtasks, combinations thereof, and/or the like. The learning/planning component may access the memory to improve subsequent applications of the learning/planning component. For instance, the learning/planning component may access the memory when generating subtasks for a particular task. The learning/planning component may identify historical subtasks associated with the particular task that failed and avoid using those subtasks. The learning/planning component may also identify historical subtasks associated with the particular task that were successful and/or executed with particular performance characteristics and select those subtasks. The memory may improve the learning/planning component and reduce a likelihood of failed tasks or subtasks. In some instances, the memory may be a region of physical memory (e.g., non-volatile or volatile memory, etc.). In other instances, the memory may be part of the machine-learning model of the learning/planning component.

The specialist agents may execute the subtasks directly, by passing the subtasks to one or more agent modules, and/or by passing the one or more subtasks to the central processor for execution. For instance, specialist modules may execute processes of an application or software service by receiving an executable block representing a process, dividing the executable block into subtasks that can be executed by an interpreter of the specialist agent, compiled into machine code and passed to the central processing unit the AI Agent Platform or processing device executing the AI Agent Platform, passed to an agent module which may execute the subtasks by interpreting or compiling the subtask, passed to an agent module which may generate code configured to implement the subtask (e.g., in implementations where the subtask is not already in code form), etc.

In some implementations, the specialist module may be configured to execute processing instructions (e.g., programming instructions, etc.). In those implementations he specialist agents may plan, schedule, interpret/compile, and invoke the processing instructions as previously described. In other implementations, the specialist module may be configured to execute tasks requested by users such as requests for information, travel planning, object acquisitions, etc. In those implementations, the AI Agent Platform may include three or more layers configured to process human-readable instructions (e.g., such as natural language communications and/or non-natural language instructions, etc.) to identify tasks, classify task categories, define intents, plan task execution, and execute tasks for users. For example, the AI Agent Platform may include an orchestrator layer, a specialist module layer, and an agent layer. In some examples, the AI Agent Platform may include additional layers between the orchestrator layer and the specialist module layer or between the specialist module layer and the agent module layer.

The orchestrator layer parses the received input to identify tasks. The orchestrator may also analyze the input for topic segmentation (e.g., classifying topics associated with natural language communications, etc.), sentiment analysis (e.g., identifying tone, intent, contexts, and/or the like from natural language communications, etc.), contextual analysis (e.g., classifying related features or modifying features that are associated may related to the identified task, etc.), combinations thereof, and/or the like. The orchestrator layer may use the task, the topic segmentation, sentiment analysis, and contextual analysis to route the task to a particular specialist module configured to execute the task or a portion of the task. For example, if the task can be implemented by a particular specialist module, the orchestrator layer passes the task to the particular specialist module. The orchestrator layer may also pass task related details such metadata, state data associated with execution of related tasks, contextual data, any of the aforementioned information derived by the orchestrator layer, and/or the like. If the task cannot be implemented by a particular specialist module, the orchestrator layer divides the task into a set of discrete tasks that each be implemented by a specialist module and pass each discrete task to a respective specialist module. The orchestrator layer may also pass task related details such metadata, state data associated with execution of related tasks, contextual data, any of the aforementioned information derived by the orchestrator layer, and/or the like.

Specialist modules (also referred to the specialist layer) are trained to implement one or more task types or domains. The specialist modules include a learning/planning component configured to divide tasks into subtasks (and learn from execution of subtasks, etc.), track the state of tasks and subtasks, etc. as previously described. The specialist modules may invoke one or more agent modules to implement the subtask. The specialist modules may use state tracking to defines a state machine. Specialist modules may include self-healing processes that provide fault tolerance during task execution. During execution of each subtask and/or after execution of each subtask, the specialist module revaluates the subtasks to determine if execution of the task is still possible. For instance, the specialist module identifies failure states (e.g., subtasks that cannot be executed or that had an execution failure, whether future subtasks in the sequence are unlikely to execute correctly or result in execution of the task, etc.). Upon detecting a failure state in a subtask, the specialist module defines new subtasks that extend from the failed subtask to improve a likelihood that the task will be executed successfully.

Agent modules (also referred to as the skill layer) are trained to implement one or more discrete subtasks. In some instances, each agent module is trained to perform a single subtask type. The agent module supports internal services of the AI Agent Platform and external application programming interfaces (APIs). The agent module handles error logic (e.g., error detection, exception handling, interrupt handling, etc.), retry logic (e.g., enabling recovery from errors, failure states, etc.), tool registry for handling new tools and libraries, and/or the like. For example, agent module may dynamically invoke APIs to facilitate execution of subtasks by external services, retrieve information, transmit information, etc. For instance, an agent module trained to interact with a calendar service may generate commands using APIs to acquire calendar information on particular dates, modify the calendar, etc. Agent modules leverage small machine-learning models that are trained to implement the subtasks of the agent module. In some implementations, the agent module may include techniques other than machine-learning such as a dynamically reconfigurable algorithms, hardcoded instruction sets, APIs, etc. to implement the functionality of the agent modules described herein.

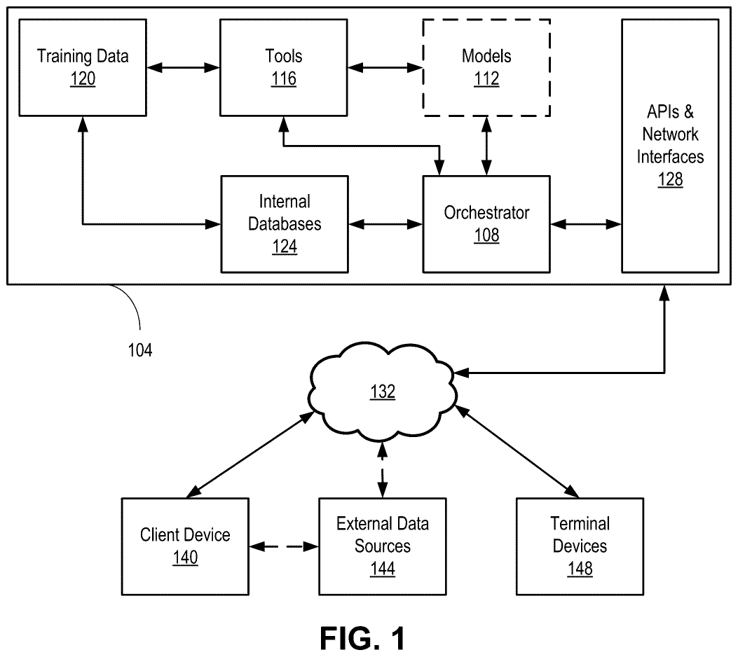

The orchestrator, specialist modules, and agent modules may each include machine-learning models trained to perform various processing tasks (e.g., task classification, intent prediction, task planning and routing, task replanning, etc.). In some examples, the machine-learning models may be incorporated into the component that operates the machine-learning model (e.g., the orchestrator may include a first one or more machine-learning models, each specialist module may include one or more machine-learning models, etc.). Alternatively, the AI Agent Platform may manage a pool of machine-learning models trained to perform various operations for the AI Agent Platform. The orchestrator, specialist modules, and/or agent modules may request execution of any particular machine-learning model by of the pool of machine-learning models (e.g., through a management layer such as the orchestrator layer, etc. as described in connection to FIG. 1). The machine-learning models may learn from previous executions orchestrator, specialist modules, and agent modules to improve task assignment, dividing tasks into subtasks (e.g., execution order of subtasks, particular defined subtasks, etc.), task and subtask execution, etc.

Examples of machine-learning models that may be trained to predict the one or more options include, but are not limited to, neural networks (e.g., such as recurrent neural networks, long short-term memory (LSTM), mask recurrent neural networks, convolutional neural networks, faster convolutional neural networks, deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), large language models, or the like), generative adversarial networks (GANs), recurrent gated units (GRUs), etc.), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like.

In an illustrative example, an AI Agent Platform may receive an identification of a task and an intent associated with the task. The identification of the task and the intent associated with the task may be received by a computing device operated by a user. In some examples, the identification of the task and/or the intent may be encoded into a natural language communication transmitted to the AI Agent Platform from the computing device. In those examples, the AI Agent Platform may receive the natural language communication and use a natural-language processor to identify the task and intent. For instance, the natural-language processor may use topic segmentation using keyword matching, a machine-learning classifier, etc. (e.g., to classify topics, etc.), sentiment analysis (e.g., to determine intent and other behavior features, etc.), combinations thereof, and/or the like. The natural-language processor may use algorithms, keyword pairing, distance algorithms, machine-learning models, combinations thereof, and/or the like to identify the task and/or the intent. In other examples, the identification of the task and/or intent may be provided by the computing device (e.g., expressly identified by the computing device and/or the user thereof), and/or by another device operating between the computing device and the AI Agent Platform.

The AI Agent Platform may execute a specialist module using an object (e.g., a feature vector, a data structure such as a JavaScript Object Notation (JSON) object, etc.) derived from the task and the intent. the specialist module may define a sequence of subtasks configured to implement the task. The sequence of tasks may represent a chain-of-thought of the specialist module. The specialist module may include learning/planning component trained to process particular task types (e.g., tasks associated with a particular domain, etc.). The AI Agent Platform may include many specialist modules with some specialist modules being trained to process different task types from other specialist modules. The learning/planning component may be static (e.g., generating a preset sequence of subtasks based on an input task type, etc.) or dynamic (e.g., an algorithm or machine-learning model that dynamically generates the sequence of subtasks and learns with each iteration to improve the efficiency of the learning/planning). For example, a machine-learning model may receive the object for task to plan a trip to Denver. The machine-learning model may define a first sequence of subtasks that include a first subtask that identifies travel accommodations, a second subtask that identifies hotel accommodations, a third subtask that identifies activities in Denver, etc. The machine-learning model may learn from execution of the task and subtasks to improve how subtasks are defined. For instance, the machine-learning model may select (or redefine) previously executed subtasks that executed successfully and avoid selecting (or redefining) subtasks that executed unsuccessfully.

Examples of machine-learning models that may be trained to predict the one or more options include, but are not limited to, neural networks (e.g., such as recurrent neural networks, long short-term memory (LSTM), mask recurrent neural networks, convolutional neural networks, faster convolutional neural networks, deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), large language models, or the like), generative adversarial networks (GANs), recurrent gated units (GRUs), etc.), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like.

The training data may be derived from previous iteration of agent modules and/or the AI Agent Platform, manually and/or procedurally generated data, data derived from users and/or user agents, combinations thereof, and/or the like. The machine-learning models may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

The specialist module may facilitate execution of a first subtask of the sequence of subtasks. In some examples, the specialist module may execute the first task directly using an interpreter, a compiler, a code generator (e.g., configured to represent the first subtask as a sequence of executable instructions, etc.), and/or the like. In other examples, the specialist module may execute the first task indirectly by invoking an agent module with the first subtask. The agent module may be selected based on am ability of the agent module to execute a task type that correspond to the first subtask. Agent modules may be trained to execute a single task type or subtask type. Agent modules may include instructions and/or machine-learning models trained to execute a task type that correspond to the first subtask. The machine-learning model may be selected based on the task type to be executed by the agent module. The machine-learning model may be any of the machine-learning models as previously described and trained according to any of the techniques as previously described. The training data may be derived from previous iteration of agent modules and/or the AI Agent Platform, manually and/or procedurally generated data, data derived from users and/or user agents, combinations thereof, and/or the like.

The specialist module may determine a state of the task in response to execution of the first subtask. When a task terminates, the execution details may be returned to the specialist module from the agent module. The execution details may indicate whether the first subtask executed successfully or terminated in a failure condition (e.g., execution resulted in an error, fault, exception, interrupt, etc. ; the agent module failed to execute the subtask; the subtask executed with inaccurate or incorrect results; combinations thereof; and/or the like). The specialist module may use the execution details to update a state of the subtask and a state of the overall task. In some instances, the specialist module may define by a state machine for the task that tracks the states of the task and the sequence of subtasks.

In some examples, a state of a task or subtask may include “pending” (e.g., indicating that the task or subtask has not finished executing), “success” (e.g., indicating the task or subtask executed successfully), or “failure” (e.g., indicating the task or subtask terminated in a failure condition such could not complete, an error, etc.). For example, if subtask includes accessing a calendar service via an exposed API, the subtask may be “pending” until the subtask finish executing, “success” when the subtask returns requested information, and “failure” if the subtask could not retrieve the requested information or generated some error. The state may include other features such as execution progress (e.g., a percentage of the task that has been executed, a current subtask being executed in the sequence of subtasks, etc.), information generated by subtasks that have already executed, a prediction the likelihood of success of completing the subtasks (e.g., based on the execution progress, the state, etc.), combinations, thereof, and/or the like. For instance, the state may indicate whether the task can be completed as a result of the first subtask terminating in a failure condition. If the first subtask retrieves information or instructions usable by the next subtask, then a failure condition in the first subtask may result in a failure condition for one or more remaining subtasks and the overall task.

The AI Agent Platform may execute the specialist module using a new object derived from the task and the state of the first task. The specialist module may manage execution of the task through implementation of the sequence of subtasks by agent modules. When the agent modules return execution details to the specialist module, the specialist module defines the state of the task and generates a predicted likelihood that the task can be completed. The predicted likelihood may be generated by the learning/planning component or other machine-learning model trained based on historical task executions. The predicted likelihood may be a percentage, a value between zero and one, a Boolean (e.g., success or failure, true or false, 1 or 0, etc.), and/or the like.

If the predicted likelihood is greater than a threshold (or for Boolean values, corresponds to success, true, 1, etc.), then task execution continues with the specialist module invoking another agent module to execute a second subtask in the sequence of subtasks. If the predicted likelihood is less than the threshold (or for Boolean values, corresponds to failure, false, 0, etc.), then the specialist module determines that it is unlikely that the task will be executed successfully. As a result, the specialist module may define a new object and cause the learning/planning component to define a new sequence of tasks that extends from the first task. In other words, the new sequence of tasks does not start execution of the task from the beginning but instead resumes execution of the task by the new sequence of tasks from the current state of the task. The new sequence of tasks represents a new chain-of-thought for the specialist module. Since the new chain-of-though interrupts a previous chain-of-thought, the overall reasoning of the specialist module may be represented as a graph-of-thought.

The specialist module may facilitate execution of a second subtask of the new sequence of subtasks. In some examples, the specialist module may execute the second task directly using an interpreter, a compiler, a code generator (e.g., configured to represent the second subtask as a sequence of executable instructions, etc.), and/or the like. In other examples, the specialist module may execute the second task indirectly by invoking a second agent module with the second subtask. The second agent module may be selected based on am ability of the second agent module to execute a task type that correspond to the second subtask. In some instances, the second agent module may be the first agent module (e.g., if the second subtask is of a type that can be executed by the second agent module. In other instances, the second agent module may be a different agent module from the first agent module.

Once the second subtask terminates, the execution details may be return to the specialist module and the specialist module may update the state of the task and generate a new predicted likelihood that the task will be executed successfully. If the new predicted likelihood is greater than the threshold, then the process continues where the specialist module facilitates execution of a third subtask of the new sequence of subtasks (e.g., directly by the specialist module or indirectly by a third agent module, etc.). If the new predicted likelihood is less than the threshold, then the specialist module returns to the learning/planning component where another new sequence of subtasks may be defined based on the execution details of the second subtask, the updates state, and the task. The another new sequence of subtasks may extend from the second subtasks. The specialist module may continue defining new sequences of the subtasks as needed as the task executes. This self-healing process during task execution improves the likelihood that the task will execute successfully, remediate errors conditions in subtasks, prevents error accumulation in processes from impacting execution of subsequent processes, improves an efficiency of the learning/planning component and defined subtasks, etc.

FIG. 1 illustrates a block diagram of an example AI Agent Platform trained for general task facilitation according to aspects of the present disclosure. AI Agent Platform 104 may operate as a hardware platform (e.g., as an application specific integrated circuit (ASIC), field programmable gate array (FPGA), special-purpose processing device, combinations thereof, and/or the like), a software platform (e.g., executing on a computing device, server, cloud network, a hardware platform as previously described, combinations thereof, and/or the like), or as a combination of a hardware platform and a software platform.

AI Agent Platform 104 may include orchestrator 108, which may manage communications with remote devices, identify tasks, generate and manage communications with external devices, facilitate task planning and execution and/or the like. Orchestrator 108 may receive communications from one or more external devices via APIs and network interfaces 128. APIs and network interfaces 128 may include one or more interfaces, libraries, and/or the like that enable AI Agent Platform to autonomously access and/or communicate with remote devices (e.g., such as, but not limited to, any of the aforementioned devices, etc.). APIs and network interfaces 128 is configured to translate communications into a native format such as translating received communications into a native format of AI Agent Platform 104 and/or translating communications transmitted from AI Agent Platform 104 into a native format of the receiving device. APIs and network interfaces 128 may also include interfaces that facilitate access to functions of other devices (e.g., such as, but not limited to, APIs exposed by the other devices, etc.), which enable AI Agent Platform 104 to autonomously access and/or manipulate remote devices.

In some implementations, orchestrator 108 is configured to communicate with users using natural language communications, identify tasks within natural language communication, and execute identified tasks. For example, client device 140 may connect to AI Agent Platform 104 via APIs and network interfaces 128 and establish a communication session between orchestrator 108 and client device 140. The communication session may text-based, audio-based, and/or audiovisual-based. Orchestrator 108 may establish communication session or receive communication from other external devices such as, terminal devices 148 (and/or the users thereof, which are referred to herein as agents), external services 144, and/or the like via APIs and network interfaces 128. External services 144 may include services associated with client device 140 and/or the user thereof, services that may provide information or facilitate execution of tasks or subtasks, combinations thereof, and/or the like. Examples of external services include, but are not limited to, information sources (e.g., databases, webpages, services subscribed to by the user, etc.), e-commerce platforms, home automation devices, Internet-of-Things devices, wearable devices, sensors, subscription services, combinations thereof, and/or the like.

In other implementations, AI Agent Platform 104 may operate in an autonomous system without any user interaction. In those implementations, AI Agent Platform 104 may process data received from one or more devices and/or services such as, but not limited to, Internet-of-Things devices, sensors, and/or any other data stream. In still yet other implementations, AI Agent Platform 104 may operate on a combinations of received data from automated services or devices and user communications.

Client device 140 may establish a communication session with orchestrator 108 may to enable access to services provided by orchestrator 108. The communication session may be an environment through which real-time and/or non-real-time communications can be exchanged between client device 140 and AI Agent Platform 104. In some examples, orchestrator 108 may include an automated communication service that may communicate with client device 140 via the communication session. In other examples, the automated communication service may be a component of tools 116 and access by orchestrator 108. The automated communication service may process natural language communications in any format (e.g., alphanumeric text, audio segments, video segments, and/or the like). In some instances, the automated communication service may include one or more models that can parse communications and generate responses (e.g., such as natural language models, large language models, etc.). In other instances, the automated communication service may include non-machine-learning algorithms, which may use less processing resources at the expense of more limited communication functionality. The automated communication service may include a classification layer that may identify tasks within communications, assign a task category to identified tasks, perform semantic/lexical analysis on communications (e.g., to identify user intent, intensity (e.g., tonal analysis, etc.), mood, combinations thereof, and/or the like), combinations thereof, and/or the like.

Upon establishing a communication session with client device 140, orchestrator 108 may retrieve any relevant information associated with client device 140 and/or the user thereof to enhance a context of services provided by AI Agent Platform 104 and to provide more relevant recommendations to client device 140 and/or the user thereof. For example, orchestrator 108 may retrieve a family profile associated with client device 140 and/or the user thereof. The family profile may include information known about the user including, but not limited to, information received from the user, communications between the user and AI Agent Platform 104 (e.g., such as communications with orchestrator 108, terminal devices 148, etc.), task facilitated by AI Agent Platform 104, information associated with the user (e.g., information generated through operations of AI Agent Platform 104, etc.), demographic information, family information, combinations thereof, and/or the like. AI Agent Platform 104 may add to the family profile each time there is an interaction with the user, information associated with the user is generated by AI Agent Platform 104, and/or information associated with the user is received by AI Agent Platform 104. The family profile may be used to tailor operations of AI Agent Platform 104 to the user, which may modify how communications are generated and/or transmitted, how tasks are recommend and/or executed, etc. If no family profile can be identified, then orchestrator 108 may identify a family profile associated with a related user to the user (e.g., such as family member, etc.), which may include references to the user. If no such family profile can be identified, then orchestrator 108 may instantiate a new family profile by requesting predetermined information from the user. Orchestrator 108 may retrieve other information associated with client device 140 and/or the user thereof in addition to or in place of the family profile such as, but not limited to, information stored by client device 140 and/or associated with client device 140, external services such as services subscribed to by a user of client device 140, sensors connected to or associated with client device 140, IoT devices connected to or associated with client device 140, home automation devices connected to or associated with client device 140, or any other data source.

AI Agent Platform 104 may include one or more machine-learning model that provide some of the operations of AI Agent Platform 104 such as automated communication services, identification of tasks and/or events, processing real-time and non-real time data streams, generating implementations of tasks and/or events, combinations thereof, and/or the like. In some examples, AI Agent Platform 104 may include one or more machine-learning models in models 112. Models 112 may store models directly operated by orchestrator 108, specialist modules, and/or agent modules. Orchestrator 108 may be configured to instantiate, train, manage, and/or the like the machine-learning models of models 112. For example, when a new agent module is needed, orchestrator may instantiate the agent module (from a new model or an existing model) and train the agent module according to the task the agent module is to perform.

Examples of machine-learning models that may be trained to predict the one or more options include, but are not limited to, neural networks, recurrent neural networks, long short-term memory (LSTM), mask recurrent neural networks, convolutional neural networks, faster convolutional neural networks, deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), large language models, or the like), generative adversarial networks (GANs), recurrent gated units (GRUs), etc.), decision trees, statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like.

Orchestrator 108 may train the one or more machine-learning models using historical operations of AI Agent Platform 104, the family profile associated with client device 140, communications of the client device 140, procedurally and/or manually generated data, data from one or more databases, web-based data (e.g., from a web-crawler, etc.), combinations thereof, and/or the like. For example, orchestrator 108 may store information received from client device 140, information associated with client device 140 and/or the user thereof, etc. in internal databases 124. AI Agent Platform 104 may use the information to define a family profile of the user in internal databases 124. The family profile may also include information associated with one or more related users such as users that are related to the user (e.g., family, friends, etc.), users in a same household, etc. In some instances, the machine-learning models of models 112 may be trained to be generally applicable (e.g., user agnostic, etc.) to enable the models to be usable for different users. In those instances, the family profile may not be used in training. Alternatively, the family profile of different users may be used in the training of the machine-learning models.

AI Agent Platform 104 may use small interchangeable machine-learning models that can be reconfigured to provide complex tasking. AI Agent Platform 104 may first instantiate the models of the orchestrator 108 (e.g., to provide natural language processing, task management, scheduling, etc.). AI Agent Platform 104 may then instantiate one or more specialist modules based on tasks to be managed by AI Agent Platform 104. Each specialist module may invoke one or more agent modules that may execute individual subtasks defined by the specialist module. As AI Agent Platform defines specialist modules, AI Agent Platform may instantiate agent modules that will be invoked by each specialist module. Specialist modules and agent modules may each include machine-learning models trained according to the tasks (or subtasks) to be executed by each respective specialist modules and agent modules. Specialist modules, for example, may be include machine-learning models trained to plan the execution of tasks, including subdividing tasks into sequence of subtasks, redefining sequence of subtasks upon detecting failure conditions, identifying agent modules to execute subtasks, tracking a state of the task, etc. In some instances, specialist modules may also include sub-agents (e.g., that may provide planning of subtasks subdividing subtasks into sequences of subtasks, etc.). Agent modules may include machine-learning models and/or processes that implement discrete subtasks. In some instances, agent models may execute a single type of subtask. In other instances, agent models may execute two or more types of subtasks. Orchestrator 108 and/or specialist modules may chain agent modules to implement complex subtasks or tasks. Orchestrator 108 and/or specialist modules may also rearrange agent modules to provide varying functionality.

Orchestrator 108 may parse input from client devices including natural language inputs. Orchestrator 108 may classify inputs to identify tasks and a corresponding task type. Orchestrator 108 may invoke a specialist module configured to process the detected task type. The specialist module may parse the task type and generate a set of subtasks that when executed, implement the task. The set of subtasks may include sequences of subtasks (e.g., defined for serial processing), collections of tasks (e.g., defined for serial or parallel processing), and/or combinations thereof. For instance, some subtasks may be dependent on other subtasks causing the subtasks to execute sequentially. Other subtasks may not include dependencies or may only be dependent on some subtasks. These subtasks may be executed in parallel with other subtasks. The specialist modules may define an execution order that includes sequential and/or parallel subtask execution. The execution order may be based primarily on dependencies but may also be based on execution efficiency (e.g., execution rate, resource utilization, etc.) or execution security (e.g., fault tolerance, etc.). For instance, the specialist module may define the execution order of subtasks according to dependencies, then optimize the execution order to improve an execution rate (e.g., by executing any non-dependent-based subtasks in parallel with other subtasks), resource utilization (e.g., by executing subtasks sequentially to reduce a processing resource utilization, etc.), execution security (e.g., by executing subtasks in an order that reduces a likelihood of generating faults or in an order in which recovering from a fault is more likely, etc.), combinations thereof, and/or the like.

In some instances, orchestrator 108 and/or specialist modules may determine that a task cannot be divided into subtasks. In those instances, orchestrator 108 or the specialist module may execute the task directly (e.g., without invoking an agent module, etc.). For instance, client device 140 may transmit a natural language communication including a query for information. Orchestrator 108 may determine that orchestrator 108 is capable of structuring a query to an information source (e.g., a database, the Internet, etc.) and generate a natural language response including the requested information. Alternatively, orchestrator 108 may pass the query to a specialist module and the specialist module may determine that the task can be executed directly by the specialist module without passing the task an agent module.

Orchestrator 108 may determine whether to execute a task directly or to invoke a specialist module to execute the task. For instance, orchestrator 108 may include a classifier and/or decisioning module configured to determine how to route tasks including tasks that can be executed directly by orchestrator 108. In some instances, orchestrator 108 may execute any task that orchestrator 108 is capable of executing directly and invoke specialist modules for tasks that orchestrator 108 cannot execute directly. In other instances, orchestrator 108 may determine whether to execute tasks directly or to invoke a specialist module based on execution efficiency, execution security, and/or the like. For instance, orchestrator 108 may determine when to pass tasks that can be executed by orchestrator 108 directly to maximize an execution rate, etc. In still yet other instances, orchestrator 108 may pass all tasks to specialist modules regardless of whether orchestrator 108 is capable of executing a task directly.

In some instances, specialist modules may execute any task received from orchestrator 108 that the specialist modules are capable of executing directly. A specialist module may invoke agent modules for tasks that the specialist module cannot execute directly. In other instances, specialist modules may determine whether to execute a task directly or to invoke an agent module to execute the task based on execution efficiency, execution security, and/or the like. For instance, a specialist module may execute a task directly upon a determination that doing so will increase a task execution rate, or reduce processing resource utilization, etc. In still yet other instances, the specialist module may pass all tasks to agent modules regardless of whether specialist module is capable of executing a task directly.

Training data 120 may include the evaluation data from tools 116 and data from internal databases 124. Orchestrator 108 may define training datasets by accessing tools 116. The training datasets may be defined based on the type of machine-learning model being trained, the training algorithm (e.g., supervised learning, unsupervised learning, semi-supervised learning, metalearning, transfer learning, etc.), and the tasks or subtasks to be executed by the machine-learning model being trained. Orchestrator 108 may use the training datasets to train the machine-learning models of models 112. The machine-learning models of models 112 (e.g., such as the models of orchestrator 108, specialist modules, agent modules, etc.) may be evaluated by tools 116 (e.g., accuracy metrics, operations data, user feedback, admin user feedback, etc.), feedback from client device 140 and/or the user thereof, terminal devices 148 and/or users thereof, and/or the like.

The machine-learning model may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

In some example operations of AI Agent Platform 104, the user of client device 140 may request various services of AI Agent Platform 104 over the communication session. For example, client device 140 may request implementation of a task (e.g., such as, but not limited to, acquisition of a product or service, implementation of an experience, etc.). Orchestrator 108 may process the communication to identify the task. Orchestrator 108 may retrieve additional information associated with the user and the task such as, but not limited to, the family profile, scheduling information, sentiment analysis to determine an intent associated with the task, combinations thereof, and/or the like. Orchestrator 108 may select a specialist module from models 112 that may be configured to execute the task. Orchestrator 108 may then transmit an identification of the task and the additional information to the selected specialist module. The specialist module receives the task and define a sequence of subtasks that will implement the task. The specialist module then invokes a first agent module that is configured to implement the first subtask. When the first subtask completes, the specialist module may invoke the next subtask. This process may continue into each of the subtasks are complete or the specialist module determines the task is complete. The specialist module may return a task response (e.g., confirmation of task execution, summary of task execution, etc.) to orchestrator 108 and orchestrator 108 may report the task response to client device 140 (e.g., using natural language communications, etc.).

Specialist modules may be self-healing to provide fault tolerant processing of tasks. For example, specialist modules may subdivide tasks into a sequence of subtasks. If a subtasks terminates in a failure condition (e.g., an error is detected, agent module cannot execute a subtask, missing information, etc.), the specialist modules can execute the subtask (e.g., using a same or different agent module) and/or re-executes the planning stage be redefining the sequence of subtasks (beginning after the failed subtask) based on the failed subtask. The new sequence of subtasks may be better able to execute the task in view of the failure condition. The specialist module may generate a new sequence of subtasks each time a failure condition is detected in a subtask. In some examples, if the same or similar subtask terminates in a failure condition more than a threshold number of times, the specialist module may automatically connect a terminal device of terminal devices 148. Terminal device may be configured to execute subtasks directly, provide missing information for the subtasks, reconfigure agent modules, interact with client device 140, combinations thereof, and/or the like. For instance, a subtask may terminate in a failure condition because an external service only takes orders verbally over a telephone. The specialist module may connect to a terminal device to enable the terminal device to execute the subtask by calling the external service and completing the order. Upon successful termination of the subtask, the specialist module may invoke the next agent module to implement the next subtask in the sequence and the terminal device may be disconnected. Alternatively, the specialist module may identify a different external service that can be executed by the agent module and execute the re-execute the subtask.

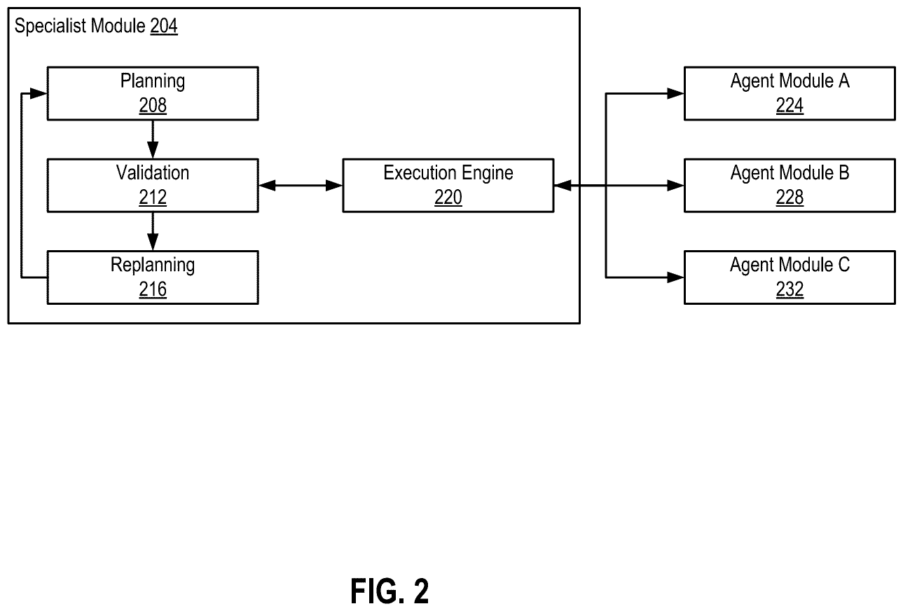

FIG. 2 illustrates a block diagram of example specialist module of the AI Agent Platform according to aspects of the present disclosure. Specialist module 204 may be a processing unit of an AI Agent Platform. The AI Agent Platform may include an orchestrator that manages execution of tasks. The orchestrator may assign tasks to specialist modules that are trained to execute particular tasks or domains. An AI Agent Platform may include multiple specialist modules with each specialist module being trained to execute different sets of tasks or domains.

Specialist module 204 may receive tasks from the orchestrator and execute planning 208 to define a sequence of subtasks that implement a task. Planning 208 may include a set of instructions or machine-learning models that are trained to define the sequence of subtasks that will implement a task. Planning 208 may include a memory of previous executions of planning 208 to improve performance and accuracy subsequent executions of planning 208. For instance, the memory may store information associated with historical tasks processed by the learning/planning component, historical subtasks defined by the learning/planning component, an identification of failed tasks, an identification of failed subtasks, an identification of a root cause of fail tasks, an identification of a root cause of failed subtasks, metadata associated historical tasks and subtasks, any other information associated with operations of planning 208, combinations thereof, and/or the like. Planning 208 may access the memory when during subtask planning to improve the quality of defined subtasks. For instance, planning 208 may define subtasks (and/or the sequent of the subtasks) that are more likely to execute successfully and avoid subtasks that are unlikely to execute successfully (based similar subtasks or sequences defined by planning 208). In some instances, the memory may be a region of physical memory (e.g., non-volatile or volatile memory, etc.) accessible by planning 208. In other instances, the memory may be part of the machine-learning model of the planning 208.

Planning 208 may schedule the execution of the sequence of subtasks in series, in parallel, a combination of in series and in parallel. For instance, subtasks with dependencies on the output of other subtasks may be executed sequentially (e.g., after the other subtasks). Subtasks that are not dependent on other subtasks can be executed at any time. These subtasks may be executed in series or in parallel with other subtasks.

Planning 208 may define an execution order that includes sequential and/or parallel subtask execution. The execution order may be based on dependencies between the subtasks. The execution order may also be based on an execution efficiency (e.g., execution rate, resource utilization, etc.) or execution security (e.g., fault tolerance, etc.). For instance, planning 208 may define the execution order of subtasks according to dependencies, then optimize the execution order to improve an execution rate (e.g., by executing any non-dependent-based subtasks in parallel with other subtasks), resource utilization (e.g., by executing subtasks sequentially to reduce a processing resource utilization, etc.), execution security (e.g., by executing subtasks in an order that reduces a likelihood of generating faults or in an order in which recovering from a fault is more likely, etc.), combinations thereof, and/or the like.

In some instances, planning 208 may determine that a task cannot be divided into subtasks. In those instances, specialist module 204 may execute the task directly (e.g., without invoking an agent module, etc.). Planning 208 may determine whether to cause specialist module 204 to execute a task directly or to invoke a specialist module to execute task. For instance, planning 208 may include a classifier and/or decisioning module configured to determine how to route tasks including tasks that can be executed directly by specialist module 204. In some instances, planning 208 may cause specialist module 204 to execute any task that specialist module 204 is capable of executing directly. In other instances, planning 208 may determine whether to execute tasks directly, to pass tasks to an agent module, and/or break up a task into subtasks for agent modules. The determination may be based on whether specialist module 204 is capable executing the task directly, a task type, execution efficiency, execution security, and/or the like. For instance, planning 208 may pass a task (or break up a task into subtasks) to increase an task execution rate, etc. In still yet other instances, planning 208 may pass all tasks to agent modules regardless of whether specialist module 204 is capable of executing a task directly or if the task can be broken up into subtasks.

Planning 208 may output the sequence of subtasks to validation 212, which may validate the sequence of subtasks to determine if the sequence of subtasks will implement the overall task. Validation 212 may also define a state machine for the task. Validation 212 may define states based on the sequence of subtasks and the execution details of subtasks as they execute. The state machine may be used to validate task and subtasks execution and to determine when to execute replanning. The sequence of subtasks may be passed to execution engine 220, which may facilitate execution the sequence of subtasks.

Execution engine 220 may execute some subtasks directly and/or indirectly. For example, some subtasks may be executed directly by execution engine 220 using an interpreter, a compiler, a code generator (e.g., configured to represent the first subtask as a sequence of executable instructions, etc.), and/or the like of specialist module 204. Execution engine 220 may invoke agent modules (e.g., such as agent module A 224, agent module B 228, and agent module C 232) to execute particular subtasks. Execution engine 220 may select particular agent modules based on the subtasks (e.g., due to agent modules being trained to execute particular subtask types, etc.), available agent modules, available processing resources, and/or the like. Execution engine 220 may receive execution details once a subtask terminates and pass the execution details to validation 212. In some cases, when a subtask executes for longer than a threshold time interval, execution engine may terminate the agent module and return a failure condition to validation 212. This prevents deadlock states, processor stalls, and other hung conditions from impacting execution of the task.

Validation 212 may receive execution details from agent modules and validate the execution details. For subtasks that result in a failure condition, validation may identify the error and the potential cause of the error. For subtasks that execute successfully, the execution details may be validated by comparing the execution details to previous instances of the execution details, identifying errors or processing failures, comparing received outputs to expected results, etc. For example, a subtask for retrieving calendar information is expected to provide date information. Validation 212 may compare the received execution details to previous instances the subtask executed to determine if the execution details conform to the expected structure and substance such as including date information, etc.

After execution of each subtask, validation 212 may determine whether to replan the remaining portions of the task. Validation 212 may generate a predicted likelihood that the task can still be executed successfully. If the predicted likelihood is greater than a threshold then validation 212 may cause execution engine 220 to execute the next subtask. If the predicted likelihood is less than a threshold then validation 212 use replanning 216 to replan the remaining subtasks in the sequence of subtask to define a new sequence of subtasks. The process may return to planning 208 and validation 212 to validate the new sequence of subtasks.

In some implementations, the predicted likelihood may be represented as a Boolean value (e.g., success or failure, etc.). For example, when a failure condition prevents subsequent subtasks from execution correctly, the predicted likelihood may be zero. And when a subtask executes successfully returning an expected output the predicted likelihood may be near 100%. That is, the predicted likelihood may be represented as a Boolean value where validation 212 determines there is a likelihood of success or a likelihood of failure. In other instances, the predicted likelihood may be a real number between 0 and 1, a percentage, an integer value between 0 and 100, etc. In those instances, the predicted likelihood may reflect both the likelihood of success given a particular subtask and given the unknowns associated with the remaining subtasks. As a result, even if subtasks execute successfully and returns expected results, the predicted likelihood may not be 100% due to inferences by validation 212 related to subsequent subtasks that are yet to execute.

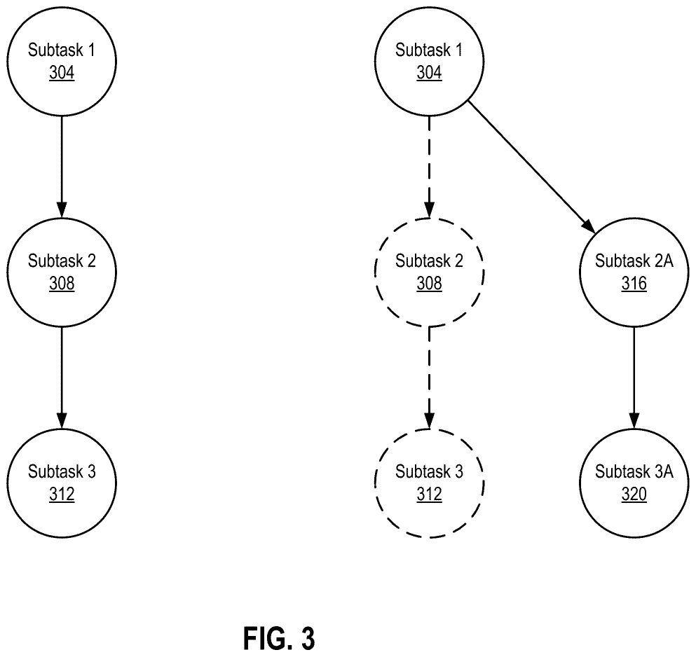

FIG. 3 illustrates a block diagram of an example self-healing chain-of-thought or graph-of-thought of specialist modules according to aspects of the present disclosure. A specialist module may be trained to execute or facilitate execution of tasks of a processing device. The specialist module may receive a task (e.g., a function, a thread, an executable block of instructions, a request from a user, etc.), define a sequence of subtasks that execute to implement the task, and execute the sequence of subtasks. The sequence of subtasks may be represented as a chain-of-thought, where one subtask (or thought) leads to a subsequent subtask (or thought), etc.

For example, a specialist module may receive a request to plan a trip to Denver. The specialist module may plan the task by dividing the task into a sequence of subtasks including subtask 1 304 (e.g., requesting calendar or preference information from a service), subtask 2 308 (e.g., obtaining flight information according to user availability), and subtask 3 312 (e.g., obtaining travel information to and from an airport based on the flight information). The specialist module may facilitate the execution of the sequence of subtasks by invoking agent modules trained to execute particular subtask types. For example, the specialist module may invoke a first agent module that is trained to communicate with a calendar service associated with the user. The specialist module may invoke a second agent module that is trained to access an air-travel service to obtain flights information. The specialist module may invoke a second agent module that is trained to identify travel routes to the airport. Agent modules may access APIs or code libraries and construct requests to internal services (e.g., storage locations, other specialist modules, other agent modules, etc.) and external services (e.g., external applications, webpages, web-services, external devices, external databases or knowledge basis, etc.).

The sequence of tasks does not always execute successfully. For example, a subtask may terminate in a failure condition due to an unhandled error or generate incorrect or inaccurate information that cannot be used by a subsequent subtask. The specialist module may use self-healing techniques during execution of tasks to recover from failure conditions or instances where the task may not execute successfully. Specialist modules may track the state of the task and the sequence of subtasks. The state information along with execution details of each subtask may be used to generate a prediction of the likelihood that the overall task will execute successfully. For example, if subtask 1 304 terminates unsuccessfully (e.g., due to an error or a failure to retrieve the calendar information, etc.), then the predicted likelihood that the task will be executed successfully will drop below a threshold. For instance, subtask 2 308 and subtask 3 312 cannot be executed because there is no date information to retrieve the flight information, which may cause the entire task to fail. The specialist module may generate a predicted likelihood after execution of each subtask. If the predicted likelihood is less than a threshold, then the specialist module will trigger replanning of the task.

The specialist module may generate a new sequence of subtasks that extend from the most recently executed subtask. Returning to the previous example, the specialist module may generate a new sequence of subtasks that includes subtask 1 304 (which caused the replanning operation), subtask 2A 316, and subtask 3A 320. The subtasks that are no longer within the chain-of-thought (e.g., subtask 2 308 and subtask 312) may not be executed. In some examples, the subtasks that are no longer within the chain-of-thought may be used for retraining the planning component of the specialist module to improve how the specialist module generates sequence of subtasks for tasks. This process may continue after execution of each subtask to create a branching sequence that executes the task. Since the planning is reevaluated at each stage of execution, the specialist module can validate agent module operations and results, improve planning tasks and subtasks, and dynamically reconfigure task execution to mitigate failure conditions.

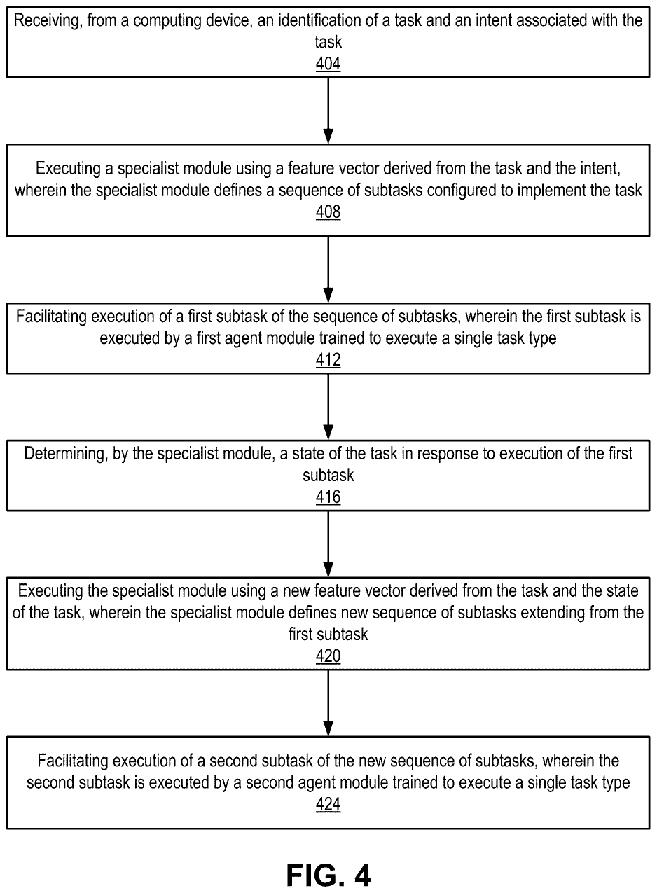

FIG. 4 illustrates a flowchart of an example process implementing self-healing AI within task facilitation according to aspects of the present disclosure. At block 404, a processing device of may receive an identification of a task and an intent associated with the task. The processing device may be a computing device, server, terminal device, mobile device (e.g., smartphone, tablet, etc.), and/or the like. In some implementations, the processing device may be a component of an AI Agent Platform (e.g., such as AI Agent Platform 104 of FIG. 1, etc.) operating within the AI Agent Platform or connected thereto via a network. In other implementations, the processing device may operate an instance of the AI Agent Platform (e.g., as an application, operating system, virtual machine, etc.). In still yet other implementation, the processing device may operate as a processing node within a distributed environment that operates the AI Agent Platform. The identification of the task and the intent associated with the task may be received by a computing device operated by a user. In some examples, the identification of the task and/or the intent may be encoded into a natural language communication transmitted to the AI Agent Platform from the computing device. In those examples, the AI Agent Platform may receive the natural language communication and use a natural-language processor to identify the task and intent. For instance, the natural-language processor may use topic segmentation using keyword matching, a machine-learning classifier, etc. (e.g., to classify topics, etc.), sentiment analysis (e.g., to determine intent and other behavior features, etc.), combinations thereof, and/or the like. The natural-language processor may use algorithms, keyword pairing, distance algorithms, machine-learning models, combinations thereof, and/or the like to identify the task and/or the intent. In other examples, the identification of the task and/or intent may be provided by the computing device (e.g., expressly identified by the computing device and/or the user thereof), and/or by another device operating between the computing device and the AI Agent Platform.

At block 408, the processing device may execute a specialist module using an object (e.g., a feature vector, a data structure such as a JavaScript Object Notation (JSON) object, etc.) derived from the request and the intent associated with the request. The specialist module may define a sequence of subtasks configured to implement the task. In some implementations. the specialist module may include one or more machine-learning models that define a sequence of subtasks that implement the task. In other implementations, the specialist module may use deterministic techniques to define the sequence of subtasks based on an identification of the task, a task type corresponding the task, the intent, a topic, combinations thereof, and/or the like. The sequence of tasks may represent a chain-of-thought of the specialist module. The specialist module may include a planning component trained to process particular task types (e.g., tasks associated with a particular domain, etc.). The processing device may include many specialist modules with some specialist modules being trained to process different task types from other specialist modules. The learning/planning component may be static (e.g., generating a preset sequence of subtasks based on an input task type, etc.) or dynamic (e.g., an algorithm or machine-learning model that dynamically generated the sequence of subtasks and learns with each iteration to improve the efficiency of the learning/planning. For example, a machine-learning model may receive the object including a task to plan a trip to Denver. The machine-learning model may define a first sequence of subtasks that include a first subtask that identifies travel accommodations, a second subtask that identifies hotel accommodations, a third subtask that identifies activities in Denver, etc. The machine-learning model may learn from execution of the task to improve how subtasks are defined (e.g., defining new subtasks, preventing unsuccessful subtasks from being defined, providing subtask definitions, etc.).

Examples of machine-learning models that may be trained to predict the one or more options include, but are not limited to, neural networks (e.g., such as recurrent neural networks, long short-term memory (LSTM), mask recurrent neural networks, convolutional neural networks, faster convolutional neural networks, deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), large language models, or the like), generative adversarial networks (GANs), recurrent gated units (GRUs), etc.), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like.

The training data may be derived from previous iteration of agent modules and/or the AI Agent Platform, manually and/or procedurally generated data, data derived from users and/or user agents, combinations thereof, and/or the like. The machine-learning models may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

At block 412, the specialist module may facilitate execution of a first subtask of the sequence of subtasks. In some examples, the specialist module may execute the first task directly using an interpreter, a compiler, a code generator (e.g., configured to represent the first subtask as a sequence of executable instructions, etc.), and/or the like. In other examples, the specialist module may execute the first task indirectly by invoking an agent module with the first subtask. The agent module may be selected based on am ability of the agent module to execute a task type that correspond to the first subtask. Agent modules may be trained to execute a single task type or subtask type. Agent modules may include instructions and/or machine-learning models trained to execute a task type that correspond to the first subtask. The machine-learning model may be selected based on the task type to be executed by the agent module. The machine-learning model may be any of the machine-learning models as previously described and trained according to any of the techniques as previously described. The training data may be derived from previous iteration of agent modules and/or the processing device, manually and/or procedurally generated data, data derived from users and/or user agents, combinations thereof, and/or the like.

At block 416, the specialist module may determine a state of the task in response to execution of the first subtask. When a task terminates, the execution details may be returned to the specialist module from the agent module. The execution details may indicate whether the first subtask executed successfully or terminated in a failure condition (e.g., execution resulted in an error, fault, exception, interrupt, etc. ; the agent module failed to execute the subtask; the subtask executed with inaccurate or incorrect results; combinations thereof; and/or the like). The specialist module may validate the execution details. The execution details may be validated by comparing the execution details to previously received execution details, identifying errors or processing failures, comparing received outputs to expected results, etc. For example, a subtask for retrieving calendar information is expected to provide date information. Validation 212 may compare the received execution details to previous instances the subtask executed to determine if the execution details conform to the expected structure and substance such as including date information, etc. The specialist module may use the execution details to update a state of the subtask and a state of the overall task. In some instances, the specialist module may define by a state machine for the task that tracks the states of the task and the sequence of subtasks.

In some examples, a state of a task or subtask may include “pending” (e.g., indicating that the task or subtask has not finished executing), “success” (e.g., indicating the task or subtask executed successfully), or “failure” (e.g., indicating the task or subtask terminated in a failure condition such could not complete, an error, etc.). For example, if subtask includes accessing a calendar service via an exposed API, the subtask may be “pending” until the subtask finish executing, “success” when the subtask returns requested information, and “failure” if the subtask could not retrieve the requested information or generated some error. The state may include other features such as execution progress (e.g., a percentage of the task that has been executed, a current subtask being executed in the sequence of subtasks, etc.), information generated by subtasks that have already executed, a prediction the likelihood of success of completing the subtasks (e.g., based on the execution progress, the state, etc.), combinations, thereof, and/or the like. For instance, the state may indicate whether the task can be completed as a result of the first subtask terminating in a failure condition. If the first subtask retrieves information or instructions usable by the next subtask, then a failure condition in the first subtask may result in a failure condition for one or more remaining subtasks and the overall task.

At block 420, the processing device may execute the specialist module using a new object (e.g., a new feature vector, a new data structure such as a JavaScript Object Notation (JSON) object, etc.) derived from the task and the state of the first task. The specialist module may manage execution of the task through implementation of the sequence of subtasks by agent modules. When the agent modules return execution details to the specialist module, the specialist module defines the state of the task and generates a predicted likelihood that the task can be completed. The predicted likelihood may be generated by the learning/planning component or other machine-learning model trained based on historical task executions. The predicted likelihood may be a percentage, a value between zero and one, a Boolean (e.g., success or failure, true or false, 1 or 0, etc.), and/or the like.

If the predicted likelihood is greater than a threshold (or for Boolean values, corresponds to success, true, 1, etc.), then task execution continues with the specialist module invoking another agent module to execute a second subtask in the sequence of subtasks. If the predicted likelihood is less than the threshold (or for Boolean values, corresponds to failure, false, 0, etc.), then the specialist module determines that it is unlikely that the task will be executed successfully. As a result, the specialist module may define a new object and cause the learning/planning component to define a new sequence of tasks that extends from the first task. In other words, the new sequence of tasks does not start execution of the task from the beginning but instead resumes execution of the task by the new sequence of tasks from the current state of the task. The new sequence of tasks represents a new chain-of-thought for the specialist module. Since the new chain-of-though interrupts a previous chain-of-thought, the overall reasoning of the specialist module may be represented as a graph-of-thought.

At block 424, the specialist module may facilitate execution of a second subtask of the new sequence of subtasks. In some examples, the specialist module may execute the second task directly using an interpreter, a compiler, a code generator (e.g., configured to represent the second subtask as a sequence of executable instructions, etc.), and/or the like. In other examples, the specialist module may execute the second task indirectly by invoking a second agent module with the second subtask. The second agent module may be selected based on am ability of the second agent module to execute a task type that correspond to the second subtask. In some instances, the second agent module may be the first agent module (e.g., if the second subtask is of a type that can be executed by the second agent module. In other instances, the second agent module may be a different agent module from the first agent module.

Once the second subtask terminates, the execution details may be return to the specialist module and the specialist module may update the state of the task and generate a new predicted likelihood that the task will be executed successfully. If the new predicted likelihood is greater than the threshold, then the process continues where the specialist module facilitates execution of a third subtask of the new sequence of subtasks (e.g., directly by the specialist module or indirectly by a third agent module, etc.). If the new predicted likelihood is less than the threshold, then the specialist module returns to the learning/planning component where another new sequence of subtasks may be defined based on the execution details of the second subtask, the updates state, and the task. The another new sequence of subtasks may extend from the second subtasks. The specialist module may continue defining new sequences of the subtasks as needed as the task executes. This self-healing process during task execution improves the likelihood that the task will execute successfully, remediate errors conditions in subtasks, prevents error accumulation in processes from impacting execution of subsequent processes, improves an efficiency of the learning/planning component and defined subtasks, etc.

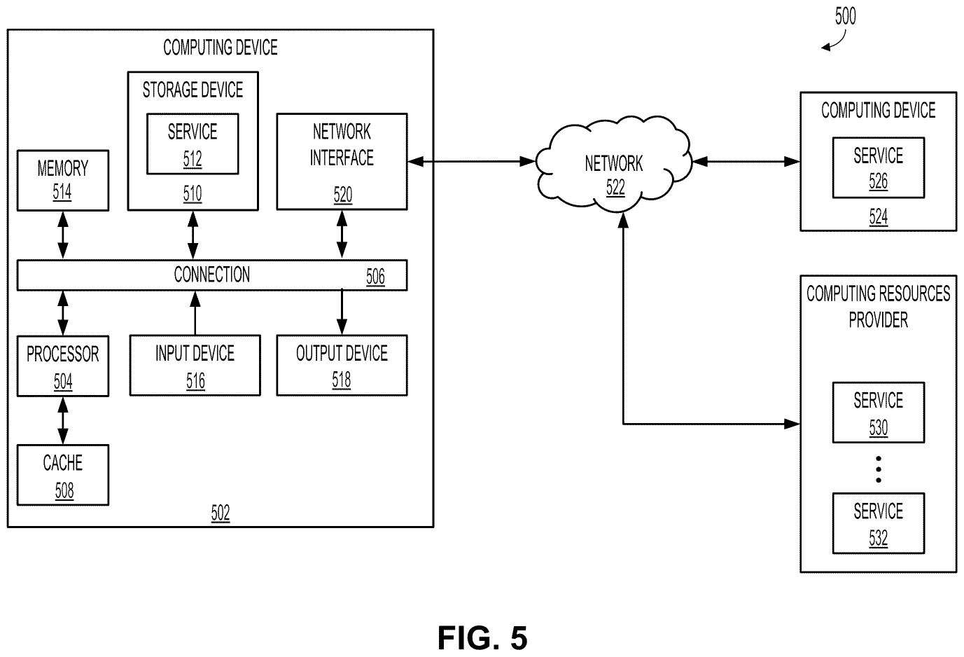

FIG. 5 illustrates an example computing device architecture of an example computing device that can implement the various techniques described herein according to aspects of the present disclosure. The example computing system 500 illustrated in FIG. 5 includes a computing device 502, which has various components in electrical communication with each other using a connection 506, such as a bus, in accordance with some implementations. The example computing system 500 includes a processor 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system 500 includes a cache 508 of high-speed memory connected directly with, in close proximity to, or integrated as part of the processor 504. The computing system 500 can copy data from the system memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The system memory 514 may be referred to herein as system memory or computer system memory. The system memory 514 may include, at various times, elements of an operating system, one or more applications, data associated with the operating system or the one or more applications, or other such data associated with the computing device 502.

Other memory can be available for use as well. The memory can include multiple different types of memory with different performance characteristics. The processor 504 can include any general-purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system 500, an input device 516 can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system 500, the storage device 510 can be connected to other parts of the computing device 502 using the connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, system memory 514, input device 516, output device 518, and so forth, can carry out the functions such as those described herein.

The disclosed systems and services can be performed using a computing system such as the example computing system illustrated in FIG. 5, using one or more components of the example computing system 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the media device described herein by, for example, executing code using a processor such as processor 504 wherein the code is stored in memory such as system memory 514 as described herein. One or more of a user device, a provider server or system, a database system, or other such devices, services, or systems may include some or all of the components of the computing system such as the example computing system illustrated in FIG. 5, using one or more components of the example computing system 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The system memory 514 can be coupled to the processor 504 by, for example, a connector such as connection 506, or a bus. As used herein, a connector or bus such as connection 506 is a communications system that transfers data between components within the computing device 502 and may, in some embodiments, be used to transfer data between computing devices. The connection 506 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The system memory 514 can include random access memory (RAM) including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The system memory 514 can also include magnetic or optical data storage media including read-only (e.g., CD ROM and DVD ROM) or otherwise (e.g., CD or DVD). The memory can be local, remote, or distributed.

As described above, the connection 506 (or bus) can also couple the processor 504 to the storage device 510, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services 526 to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as system memory 514, an input device such as input device 516, and an output device such as output device 518. In such embodiments, the computing device 524 can carry out the functions such as those described herein in connection with computing device 502. In some embodiments, the computing device 502 can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 502 and presented to a user of the computing device 502 using forms that are perceptible via sight, sound, smell, taste, touch, or other such mechanisms. In some embodiments, communications over the network 522 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 502 and/or the computing device 524 can be connected to a computing resources provider 528 via the network 522 using a network interface such as those described herein (e.g., network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the one or more services 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: receiving, from a computing device, an identification of a task and an intent associated with the task; executing a specialist module using an object derived from the task and the intent, wherein the specialist module defines a sequence of subtasks configured to implement the task; facilitating execution of a first subtask of the sequence of subtasks, wherein the first subtask is executed by a first agent module trained to execute a single task type; determining, by the specialist module, a state of the task in response to execution of the first subtask; executing the specialist module using a new object derived from the task and the state of the task, wherein the specialist module defines new sequence of subtasks extending from the first subtask; and facilitating execution of a second subtask of the new sequence of subtasks, wherein the second subtask is executed by a second agent module trained to execute a single task type.

Example 2 is the method of example(s) 1, wherein the task is identified from natural language communications.

Example 3 is the method of example(s) 1, wherein at least one subtask of the new sequence of subtasks is also included in the sequence of subtasks.

Example 4 is the method of example(s) 1, wherein the second subtask in the new sequence of subtasks is different from a corresponding second subtasks in the sequence of subtasks.

Example 5 is the method of example(s) 1, wherein a third subtask in the new sequence of subtasks is equivalent to a corresponding third subtasks in the sequence of subtasks.

Example 6 is the method of example(s) 1, wherein the new sequence of subtasks is different from the sequence of subtasks.

Example 7 is the method of example(s) 1, wherein the specialist module tracks an execution state of each agent module.

Example 8 is the method of example(s) 1, wherein the state of the task is a prediction that the sequence of subtasks is unable to implement the task.

Example 9 is the method of example(s) 1, wherein the first agent module and the second agent module are different agent modules.

Example 10 is the method of example(s) 1, wherein the sequence of subtasks is configured to executed by a plurality of agent modules, wherein each agent module is configured to execute a single task type.

Example 11 is the method of example(s) 1, wherein the specialist module derives a state of the task after execution of each subtask, and wherein the specialist module uses the state of the task to recover from failure states.

Example 12 is the method of example(s) 1, further comprising: determining, by the specialist module, an updated state of the task in response to execution of the second subtask of the new sequence of subtasks; executing the specialist module using a new object derived from the task and the updated state of the task, wherein the specialist module defines different sequence of subtasks extending from the second subtask of the new sequence of subtasks; and facilitating execution of a third subtask of the different sequence of subtasks, wherein the first subtask is executed by a third agent module trained to execute a single task type.

Example 13 is the method of example(s) 1, wherein the first agent module accesses an application programming interface to facilitate execution of the first subtask by an external service.

Example 14 is a system comprising: one or more processors; and a non-transitory computer-readable medium storing instructions that when executed by the one or more processors, cause the one or more processors to perform the methods of any of example(s) 1-13.

Example 15 is a non-transitory computer-readable medium storing instructions that when executed by one or more processors, cause the one or more processors to the methods of any of example(s) 1-13.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
receiving, from a computing device, an identification of a task and an intent associated with the task;
executing a specialist module using an object derived from the task and the intent, wherein the specialist module defines a sequence of subtasks configured to implement the task;
facilitating execution of a first subtask of the sequence of subtasks, wherein the first subtask is executed by a first agent module trained to execute a single task type;
determining, by the specialist module, a state of the task in response to execution of the first subtask;
executing the specialist module using a new object derived from the task and the state of the task, wherein the specialist module defines new sequence of subtasks extending from the first subtask; and
facilitating execution of a second subtask of the new sequence of subtasks, wherein the second subtask is executed by a second agent module trained to execute a single task type.

2. The method of claim 1, wherein the task is identified from natural language communications.

3. The method of claim 1, wherein at least one subtask of the new sequence of subtasks is also included in the sequence of subtasks.

4. The method of claim 1, wherein the second subtask in the new sequence of subtasks is different from a corresponding second subtasks in the sequence of subtasks.

5. The method of claim 1, wherein a third subtask in the new sequence of subtasks is equivalent to a corresponding third subtasks in the sequence of subtasks.

6. The method of claim 1, wherein the new sequence of subtasks is different from the sequence of subtasks.

7. The method of claim 1, wherein the specialist module tracks an execution state of each agent module.

8. A system comprising:
one or more processors; and
a non-transitory computer-readable medium storing instructions that when executed by the one or more processors, cause the one or more processors to perform operations including:
receiving, from a computing device, an identification of a task and an intent associated with the task;
executing a specialist module using an object derived from the task and the intent, wherein the specialist module defines a sequence of subtasks configured to implement the task;
facilitating execution of a first subtask of the sequence of subtasks, wherein the first subtask is executed by a first agent module trained to execute a single task type;
determining, by the specialist module, a state of the task in response to execution of the first subtask;
executing the specialist module using a new object derived from the task and the state of the task, wherein the specialist module defines new sequence of subtasks extending from the first subtask; and
facilitating execution of a second subtask of the new sequence of subtasks, wherein the second subtask is executed by a second agent module trained to execute a single task type.

9. The system of claim 8, wherein the task is identified from natural language communications.

10. The system of claim 8, wherein at least one subtask of the new sequence of subtasks is also included in the sequence of subtasks.

11. The system of claim 8, wherein the second subtask in the new sequence of subtasks is different from a corresponding second subtasks in the sequence of subtasks.

12. The system of claim 8, wherein a third subtask in the new sequence of subtasks is equivalent to a corresponding third subtasks in the sequence of subtasks.

13. The system of claim 8, wherein the new sequence of subtasks is different from the sequence of subtasks.

14. The system of claim 8, wherein the specialist module tracks an execution state of each agent module.

15. A non-transitory computer-readable medium storing instructions that when executed by one or more processors, cause the one or more processors to perform operations including:
receiving, from a computing device, an identification of a task and an intent associated with the task;
executing a specialist module using an object derived from the task and the intent, wherein the specialist module defines a sequence of subtasks configured to implement the task;
facilitating execution of a first subtask of the sequence of subtasks, wherein the first subtask is executed by a first agent module trained to execute a single task type;
determining, by the specialist module, a state of the task in response to execution of the first subtask;
executing the specialist module using a new object derived from the task and the state of the task, wherein the specialist module defines new sequence of subtasks extending from the first subtask; and
facilitating execution of a second subtask of the new sequence of subtasks, wherein the second subtask is executed by a second agent module trained to execute a single task type.

16. The non-transitory computer-readable medium of claim 15, wherein the task is identified from natural language communications.

17. The non-transitory computer-readable medium of claim 15, wherein at least one subtask of the new sequence of subtasks is also included in the sequence of subtasks.

18. The non-transitory computer-readable medium of claim 15, wherein the second subtask in the new sequence of subtasks is different from a corresponding second subtasks in the sequence of subtasks.

19. The non-transitory computer-readable medium of claim 15, wherein a third subtask in the new sequence of subtasks is equivalent to a corresponding third subtasks in the sequence of subtasks.

20. The non-transitory computer-readable medium of claim 15, wherein the new sequence of subtasks is different from the sequence of subtasks.
